(19) United States
(12) Patent Application Publication
(10) Pub. No.: US 2018/0184469 A1
(43) Pub. Date: Jun. 28, 2018

(54) METHOD FOR WIRELESSLY CONNECTING TO AN INTERNET

(71) Applicant: REALTEK SEMICONDUCTOR CORP., Hsinchu (TW)

(72) Inventors: CHIN-MIN HUANG, HSINCHU COUNTY (TW); MENG-SHIN LEE, HSINCHU CITY (TW); KAI-CHUN LIN, NEW TAIPEI CITY (TW); CHI-SHENG WANG, HSINCHU CITY (TW)

(21) Appl. No.: 15/856,137

(22) Filed: Dec. 28, 2017

(30) Foreign Application Priority Data
Dec. 28, 2016 (TW) 105143648

(51) Int. Cl. H04W 76/10; H04W 8/00; H04W 80/04

(52) U.S. Cl. CPC H04W 76/10; H04W 80/04; H04W 8/005

(57) ABSTRACT

A method for wirelessly connecting to an internet, applied for establishing a wireless connection between a mobile device and a plurality of wireless networking devices, the method including: the mobile device searching for the plurality of wireless networking devices via a wireless communication; the mobile device wirelessly connecting with a main controlling device which is one of the plurality of wireless networking devices; the mobile device providing a connection information to the main controlling device for connecting to a base station; and the main controlling device broadcasting the connection information to the other wireless networking devices of the plurality of wireless networking devices; and the main controlling device and the other wireless networking devices of the plurality of wireless networking devices connecting to the base station according to the connection information.

### BACKGROUND OF THE INVENTION

### 1. Field of the Invention

The instant disclosure relates to a method for wirelessly connecting to an internet; in particular, to a method applied to a wireless networking device for wirelessly connecting to an internet.

### 2. Description of Related Art

With the advent of Internet of Things (IoT), wireless networking technology are used more and more widely. Besides PCs and mobile phones, wireless networking technology is further applied to things in everyday life, such as toys, refrigerators, lamps, speakers, and so on. Although some products on the current market have tried to simplify setting and operation of the wireless networking devices, most of the broadcasting or multicasting data packets are assisted by an application of a mobile device, such as a mobile phone or a PC. When the wireless networking device completes the collection of connection profiles, the wireless networking device is allowed to connect to the internet. However, the setting of a wireless networking device, and in particular, the concurrent setting of a plurality of wireless networking devices is generally complicated for a user, and the efficiency thereof seldom meets user expectations. When setting a plurality of wireless networking devices at the same time, the success rate thereof is often unpredictable such that the user often needs to conduct the setting process repeatedly.

### SUMMARY OF THE INVENTION

The instant disclosure provides a method for wirelessly connecting to an internet in order to alleviate the difficulty in setting up wireless networking devices, and improve a success rate of connecting to the internet. By the assistance of applications on mobile devices or PCs, a user can easily and fully configure the wireless networking devices to be added into an existing network, such that setting up the wireless networking devices to connect to the internet becomes more easy, and that the wireless networking devices can be more widely applied.

An exemplary embodiment of the instant disclosure provides a method for wirelessly connecting to an internet, applied for establishing a wireless connection between a mobile device and a plurality of wireless networking devices. The method includes: the mobile device searching for the plurality of wireless networking devices via a wireless communication; the mobile device wirelessly connecting with a main controlling device which is one of the plurality of wireless networking devices; the mobile device providing a connection information to the main controlling device for connecting to a base station; the main controlling device broadcasting the connection information to the other wireless networking devices of the plurality of wireless networking devices; and the main controlling device and the other wireless networking devices of the plurality of wireless networking devices connecting to the base station according to the connection information.

An exemplary embodiment of the instant disclosure provides a method for wirelessly connecting to an internet, applied for establishing a wireless connection between a mobile device and a plurality of wireless networking devices including a main controlling device. The method includes: the main controlling device receiving a connection information provided by the mobile device; the main controlling device broadcasting the connection information to the other wireless networking devices of the plurality of wireless networking devices; and the main controlling device connecting to a base station according to the connection information; wherein packets broadcasted by the plurality of wireless networking devices contain a specific character that is provided to the mobile device for identification.

For further understanding of the instant disclosure, reference is made to the following detailed description illustrating the embodiments of the instant disclosure. The description is only for illustrating the instant disclosure, not for limiting the scope of the claims.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a system diagram of a system for wirelessly connecting to an internet according to one embodiment of the present disclosure;

FIG. 2 shows a flow chart of a method for wirelessly connecting to an internet according to one embodiment of the present disclosure;

FIG. 3 shows a block diagram of a wireless networking device according to one embodiment of the present disclosure;

FIG. 4 shows a flow chart of a method for wirelessly connecting to an internet by a main controlling device according to one embodiment of the present disclosure; and

FIG. 5 shows flow chart for message communication of the embodiment of FIG. 2.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

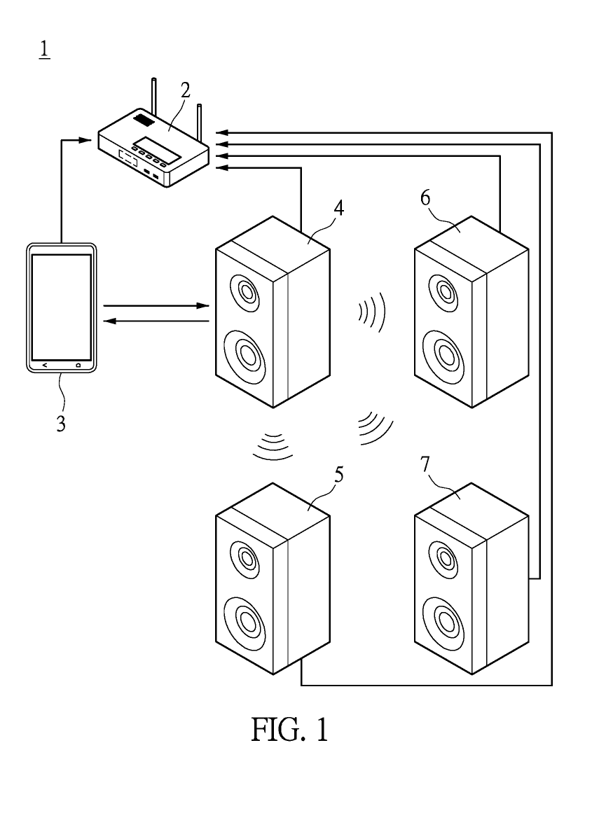

Referring to FIG. 1, a system for wirelessly connecting to an internet according to the present disclosure includes a base station 2, a mobile device 3, and a plurality of wireless networking device 4-7. The base station 2 is a Wi-Fi access point. The mobile device 3 may be a controlling device having the ability to connect to the internet, such as a smart phone, a tablet, a PC, and so on. The wireless networking devices 4-7 are controlled devices having the ability to connect to the internet. In one embodiment, the wireless networking devices 4-7 may be speakers, but the present disclosure is not limited thereto. Any electronic device, such as a TV, a lamp, a refrigerator and so on, connecting to the access point 2 via the system for wireless connecting to the internet may be the wireless networking device of the present disclosure.

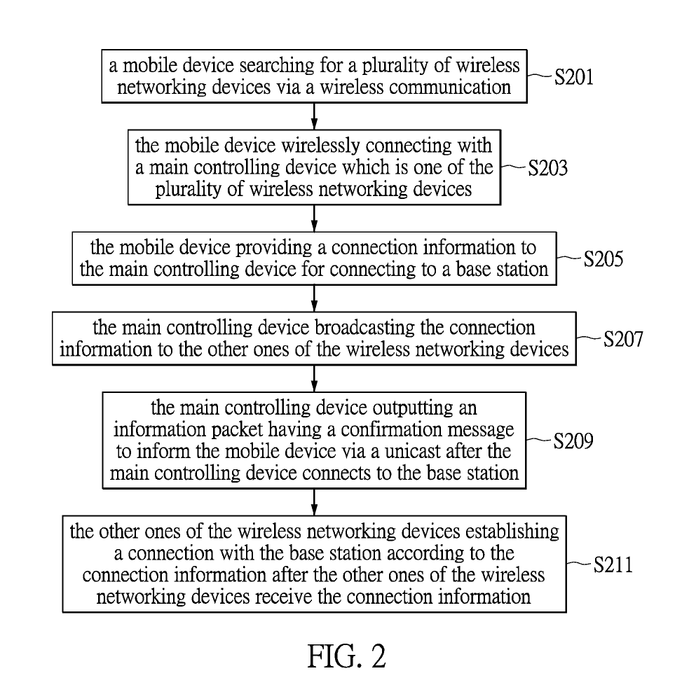

Reference is made to FIGS. 1 and 2, in which a method for wirelessly connecting to the internet according to the present disclosure is executed on the mobile device 3 and the wireless networking devices 4-7 which await connection to the internet. The method for wirelessly connecting to the internet according to the present disclosure is executed by an application which is operated by the mobile device 3, and includes: S201: the mobile device 3 searching for the plurality of wireless networking devices 4-7 via a wireless communication; S203: the mobile device 3 wirelessly connecting with a main controlling device 4 which is one of the plurality of wireless networking devices 4-7; S205: the mobile device 3 providing a connection information to the main controlling device 4 for connecting to a base station 2; S207: the main controlling device 4 broadcasting the connection information to the other ones of the wireless networking devices 5-7; S209: the main controlling device 4 outputting an information packet having a confirmation message to inform the mobile device 3 via a unicast after the main controlling device 4 connects to the base station 2; S211: the other ones of the wireless networking devices 5-7 establishing a connection with the base station 2 according to the connection information after the other ones of the wireless networking devices 5-7 receive the connection information. The wireless networking devices 4-7 have functions that support wireless connection to wirelessly connect to the internet, and broadcast broadcasting packets while the wireless networking devices 4-7 await set up for internet connection, so that the mobile device 3 searches for the wireless networking devices 4-7. In one embodiment of the present disclosure, the broadcasting packets contain a specific character. The steps S209 and S211 may be swapped.

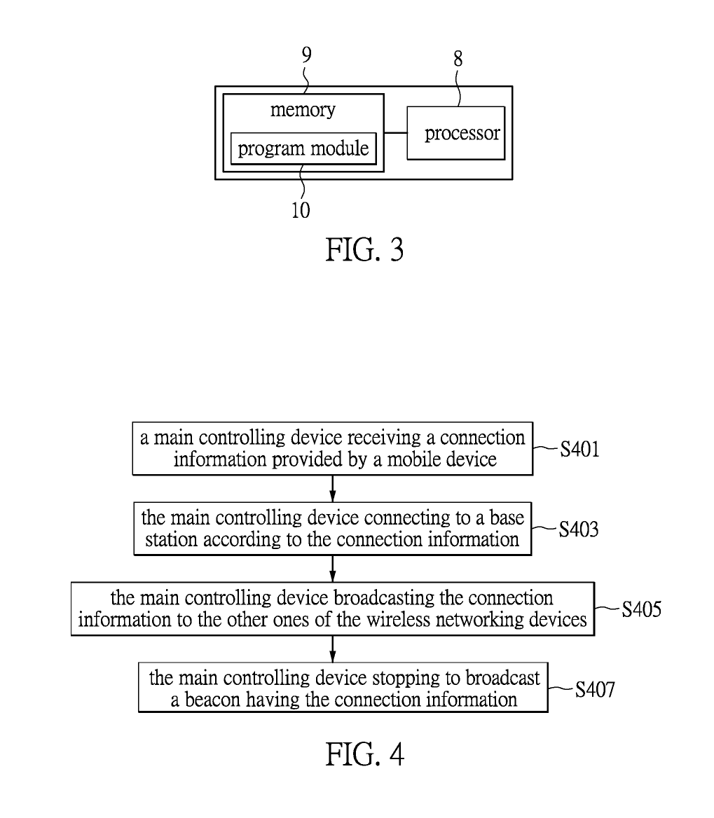

Referring to FIGS. 3 and 4, the wireless networking devices 4-7 may receive control of the mobile device 3 to connect to the base station 2. Each of the wireless networking devices 4-7 includes a processor 8, and a memory 9 that is connected to the processor 8 and that has a program module 10 executed by the processor 8. When one of the wireless networking devices 4-7 is selected to be the main controlling device, the program module 10 executed by the processor 8 executes an operation below. When the wireless networking device 4 is exemplified as the main controlling device, the operation process includes: S401: the main controlling device 4 receiving the connection information provided by the mobile device 3; S403: the main controlling device 4 connecting to the base station 2 according to the connection information; S405: the main controlling device 4 broadcasting the connection information to the other ones of the wireless networking devices 5-7; S407: the main controlling device 4 stopping broadcast of a beacon having the connection information. In addition, the mobile device 3 connects to the base station 2 and then to the internet through the base station 2 prior to the execution of the method for wirelessly connecting to the internet by the mobile device 3. During execution of the method for wirelessly connecting to the internet, the mobile device 3 disconnects with the base station 2, and when the operation process is taken over by the main controlling device 4, connects again to the base station 2. The operating sequence of foregoing steps is adjustable, for example, the main controlling device may connect to the base station after the step S407.

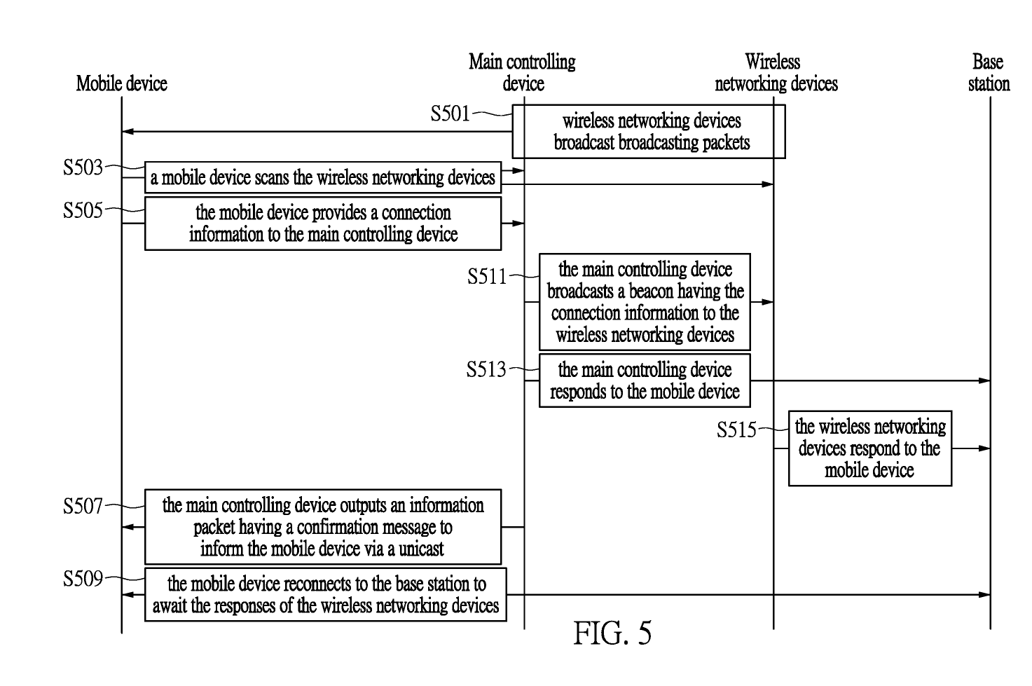

FIG. 5 shows a flow chart for message communication of the embodiment of FIG. 2 to explain an interaction between the devices in the process. Referring to FIGS. 2 and 5, in step S201, the wireless networking devices 4-7 broadcast the broadcasting packets (step S501). The mobile device 3 scans wireless networking devices in the vicinity that are available for connection to build a connection list (step S503). The mobile device 3 selects the wireless networking devices 4-7 according to whether broadcast packets broadcasted by the wireless networking devices 4-7 contain a specific character. In this embodiment, the broadcasting packets broadcasted by the wireless networking devices 4-7 all contain the specific character.

In step S203, the mobile device 3 selects the main controlling device having the best signal strength from the plurality of wireless networking devices 4-7 according to the signal strength of the signals transmitted by the plurality of wireless networking devices 4-7.

In step S205, the mobile device 3 provides the connection information for connecting to the base station 2 to the main controlling device 4 (step S505). The connection information provided by the mobile device 3 is encrypted, which includes an identification code, a login account, and a login password.

In step S207, the main controlling device 4 broadcasts a beacon having the connection information to the other wireless networking devices of the plurality of wireless networking devices 5-7 in all channels of Wi-Fi (step S511).

In step S209, the main controlling device 4 outputs an information packet having a confirmation message to inform the mobile device 3 via a unicast after the main controlling device 4 connects to the base station 2 (step S507).

In step S211, the wireless networking devices 5-7 establish a connection with the base station according to the connection information, and then respond to the mobile device 3 (step S515) after the wireless networking devices 5-7 receive the beacon.

The main controller device 4 stops the broadcast of the beacon and deletes the connection information after the main connecting device 4 stops the broadcast of the beacon having the connection information. In addition, the mobile device 3 reconnects to the base station 2 to await the responses of the wireless networking devices 4-7 after the mobile device 3 receives a confirmation message from the main controlling device 4 (step S509).

Preferably, each of the wireless networking devices 4-7 may include a reset button which could be a physical button or a virtual button. Each of the wireless networking devices 4-7 is reset to return to an initial state for broadcasting the specific packet continuously by pressing or touching the reset button of the wireless networking devices 4-7, so that the mobile device 3 scans and identifies the wireless networking device. When the wireless networking devices 4-7 lose the connection information, such as when the application is installed on a new mobile device or a usable base station is changed, the wireless networking device can be reset to return to an initial state for broadcasting the specific packet and to execute the method to connect to the internet again by pressing or touching the reset button on the wireless networking device.

Furthermore, the mobile device 3 may include a plurality of reset buttons corresponding to the wireless networking devices 4-7, where the reset buttons could be a physical button or a virtual button. The wireless networking devices 4-7 are reset to return to an initial state for broadcasting the specific packet by pressing or touching the reset button on the mobile device 3, so that the mobile device 3 scans and identifies the wireless networking devices 4-7. When the setting of the wireless networking device is changed, the wireless networking devices 4-7 can be reset to return to an initial state for broadcasting the specific packet and to execute the method to connect to the internet again by pressing or touching the reset button corresponding to the wireless networking device on the mobile device 3 or on the wireless networking device.

Based on the above-mentioned, the method and system for connecting to the internet according the present disclosure can search for wireless networking devices, transmit the connection information to specific wireless networking devices, broadcast the connection information to other wireless networking devices, and change the setting of the wireless networking devices. The method and system of the present disclosure allows users to easily and fully configure wireless networking devices to add into the internet, and to easily set up the settings of the wireless networking devices, so that wireless networking devices can become more widely applied.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A method for wirelessly connecting to an internet, applied for establishing a wireless connection between a mobile device and a plurality of wireless networking devices, the method comprising:
the mobile device searching for the plurality of wireless networking devices via a wireless communication;
the mobile device wirelessly connecting with a main controlling device which is one of the plurality of wireless networking devices;
the mobile device providing a connection information to the main controlling device for connecting to a base station; and
the main controlling device broadcasting the connection information to the other wireless networking devices of the plurality of wireless networking devices; and
the main controlling device and the other wireless networking devices of the plurality of wireless networking devices connecting to the base station according to the connection information.

2. The method according to claim 1, wherein the step of the mobile device searching for the plurality of wireless networking devices via the wireless communication includes:
scanning wireless networking devices nearby available for connection to build a connection list;
selecting the plurality of wireless networking devices according to whether broadcast packets broadcasted by the wireless networking devices contain a specific character.

3. The method according to claim 1, wherein the step of the mobile device wirelessly connecting with the main controlling device includes:
selecting the main controlling device from the plurality of wireless networking devices according to signal strength of signals transmitted by the plurality of wireless networking devices.

4. The method according to claim 1, wherein the step of the main controlling device broadcasting the connection information to the other wireless networking devices of the plurality of wireless networking devices includes:
broadcasting a beacon having the connection information.

5. The method according to claim 1, further comprising:
the mobile device reconnects to the base station.

6. A method for wirelessly connecting to an internet, applied for establishing a wireless connection between a mobile device and a plurality of wireless networking devices including a main controlling device, the method comprising:
the main controlling device receiving a connection information provided by the mobile device;
the main controlling device broadcasting the connection information to the other wireless networking devices of the plurality of wireless networking devices; and
the main controlling device connecting to a base station according to the connection information;
wherein packets broadcasted by the plurality of wireless networking devices contain a specific character that is provided to the mobile device for identification.

7. The method according to claim 6, further comprising:
the main controlling device stops broadcasting of a beacon having the connection information before the main controlling device connects with the base station.

8. The method according to claim 6, further comprising:
the main controlling device outputting an information packet having a confirmation message to inform the mobile device via a unicast after the main controlling device connects to the base station.

9. The method according to claim 6, wherein the step of the main controlling device broadcasting the connection information to the other wireless networking devices of the plurality of wireless networking devices includes:
broadcasting a beacon having the connection information.
